(19) United States
(12) Patent Application Publication
(10) Pub. No.: US 2021/0208259 A1
(43) Pub. Date: Jul. 8, 2021

(54) METHOD AND DEVICE OF NOISE FILTERING FOR LIDAR DEVICES

(71) Applicant: WeRide Corp., San Jose, CA (US)

(72) Inventor: Ji Yoon CHUNG, San Jose, CA (US)

(21) Appl. No.: 17/140,141

(22) Filed: Jan. 4, 2021

Related U.S. Application Data
(60) Provisional application No. 62/956,338, filed on Jan. 2, 2020.

(51) Int. Cl. G01S 7/487; G01S 7/48

(52) U.S. Cl. CPC G01S 7/4876; G01S 7/4808

(57) ABSTRACT

A method for noise filtering for LiDAR. The method comprises: receiving a scanned points data indicative of an environment obtained by emitting light pulses from a sensor of a vehicle into the environment where the vehicle is driving; obtaining an object region by grouping together a set of connected points within a road region representing a road surface in the environment generated based on the scanned points data, wherein each of the set of connected points comprises a non-road reflection data indicative of a reflective position not located on the road surface; acquiring one or more noise evaluation features of the object region, wherein the one or more noise evaluation features comprise whether the object region comprises at least one dual-reflection point all surrounded by other dual-reflection points; determining whether the non-road reflection data of all points within the object region are noisy data based on the one or more noise evaluation features.

### TECHNICAL FIELD

The present disclosure generally relates to a method and device of noise filtering for a sensor, more particularly, for a LiDAR device.

### BACKGROUND

The acquisition of information of objects in a real-world environment is of interest in many industries. A plurality of types of sensors can be used for obtaining the information of objects in a real-world environment, such as Light Detection and Ranging (“LiDAR”) devices and the like. Recent advances in scanning technology, such as LiDAR scanning, have resulted in the ability to collect billions of point samples on physical surfaces. A typical LiDAR sensor includes a source of optical radiation and an optical detection device. The source of optical radiation, for example, a laser, emits light into a region, and the optical detection device, which may include one or more optical detectors or an array of optical detectors, receives reflected light from the region and converts the reflected light to identify and generate information associated with one or more target objects in the region.

The developing autonomous vehicle industry also utilizes cameras and LiDAR sensors for object detection and navigation. Generally, these sensors are often mounted on an exterior of a vehicle, for example, on a roof and/or a side view mirror of the vehicle. Such camera and LiDAR sensors may become untrustworthy due to certain interferences in the environment, such as raindrops, snowflakes and dust in the air, which may be wrongly interpreted as obstructions. Therefore, there is a need for further improvement in noise filtering for a LiDAR device.

### SUMMARY

According to a first aspect of embodiments of the present disclosure, a method of noise filtering for LiDAR devices is provided. The method includes: receiving a scanned points data indicative of an environment obtained by emitting light pulses from a sensor of a vehicle into the environment where the vehicle is driving; obtaining an object region by grouping together a set of connected points within a road region representing a road surface in the environment generated based on the scanned points data, wherein each of the set of connected points comprises a non-road reflection data indicative of a reflective position not located on the road surface; acquiring one or more noise evaluation features of the object region, wherein the one or more noise evaluation features comprise whether the object region comprises at least one dual-reflection point all surrounded by other dual-reflection points; determining whether the non-road reflection data of all points within the object region are noisy data based on the one or more noise evaluation features.

According to a second aspect of embodiments of the present disclosure, a device of noise filtering for LiDAR devices is provided. The device includes: a processor; and a memory configured to store an instruction executable by the processor; wherein the processor is configured to: receive a scanned points data indicative of an environment obtained by emitting light pulses from a sensor of a vehicle into the environment where the vehicle is driving; obtain an object region by grouping together a set of connected points within a road region representing a road surface in the environment generated based on the scanned points data, wherein each of the set of connected points comprises a non-road reflection data indicative of a reflective position not located on the road surface; acquire one or more noise evaluation features of the object region, wherein the one or more noise evaluation features comprise whether the object region comprises at least one dual-reflection point all surrounded by other dual-reflection points; determine whether the non-road reflection data of all points within the object region are noisy data based on the one or more noise evaluation features.

It is to be understood that both the foregoing general description and the following detailed description are exemplary and explanatory only, and are not restrictive of the invention. Further, the accompanying drawings, which are incorporated in and constitute a part of this specification, illustrate embodiments of the invention and together with the description, serve to explain principles of the invention.

### BRIEF DESCRIPTION OF THE DRAWINGS

The drawings referenced herein form a part of the specification. Features shown in the drawing illustrate only some embodiments of the disclosure, and not of all embodiments of the disclosure, unless the detailed description explicitly indicates otherwise, and readers of the specification should not make implications to the contrary.

FIG. 1 depicts a representative autonomous driving system;

FIG. 2 depicts a flow chart of a process of noise filtering for LiDAR devices according to an embodiment of the present disclosure;

FIG. 3 depicts a flow chart of another process of noise filtering for LiDAR devices according to an embodiment of the present disclosure;

FIG. 4 depicts a flow chart of a process associated with the process of FIG. 2;

FIG. 5 depicts a flow chart of a process associated with the process of FIG. 3;

FIG. 6 depicts a flow chart of another process of noise filtering for LiDAR devices according to an embodiment of the present disclosure;

FIG. 7 depicts an environment image of a plurality of scanned points within a road region according to an embodiment of the present disclosure;

FIG. 8 depicts an environment image of a plurality of scanned points within a road region according to another embodiment of the present disclosure;

FIG. 9 depicts a schematic diagram of a device 901 of filtering noise for LiDAR devices according to an embodiment of the present disclosure;

The same reference numbers will be used throughout the drawings to refer to the same or like parts.

### DETAILED DESCRIPTION OF THE PREFERRED EMBODIMENTS

The following detailed description of exemplary embodiments of the disclosure refers to the accompanying drawings that form a part of the description. The drawings illustrate specific exemplary embodiments in which the disclosure may be practiced. The detailed description, including the drawings, describes these embodiments in sufficient detail to enable those skilled in the art to practice the disclosure. Those skilled in the art may further utilize other embodiments of the disclosure, and make logical, mechanical, and other changes without departing from the spirit or scope of the disclosure. Readers of the following detailed description should, therefore, not interpret the description in a limiting sense, and only the appended claims define the scope of the embodiment of the disclosure.

In this application, the use of the singular includes the plural unless specifically stated otherwise. In this application, the use of “or” means “and/or” unless stated otherwise. Furthermore, the use of the term “including” as well as other forms such as “includes” and “included” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described.

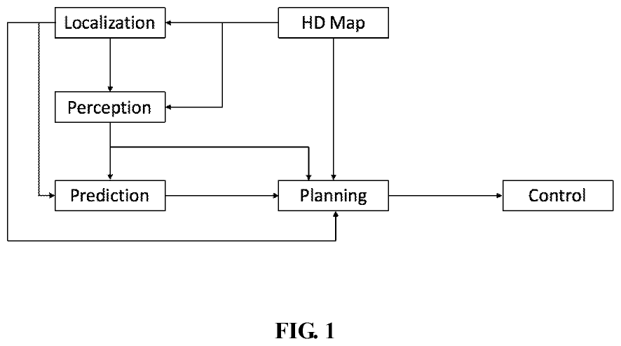

Autonomous vehicles (also known as driverless cars, self-driving cars or robot cars) are capable of sensing its environment and navigating without human input. FIG. 1 illustrates an exemplary autonomous vehicle system that comprises functional subsystems, or modules, that work collaboratively to generate signals for controlling a vehicle.

Referring to FIG. 1, a perception module of the autonomous driving system is configured to sense the surrounding of the autonomous vehicle using sensors such as camera, radar and LiDAR devices and to identify the objects around the autonomous vehicle. The sensor data generated by the sensors is interpreted by the perception module to perform different perception tasks, such as classification, detection, tracking and segmentation. Machine learning technologies, such as convolutional neural networks, have been used to interpret the sensor data. Technologies such as Kalman filter have been used to fuse the sensor data generated by different sensors for the purposes of accurate perception and interpretation.

However, the sensors of the perception module, which includes cameras that pick out road drivers or LiDAR devices, may become untrustworthy in wet weather by wrongly interpreting raindrops or snowflakes as obstructions on the road. The method and device of the present disclosure are provided to solve the above problem, especially in a system using LiDAR devices.

A LiDAR device may illuminate a target with laser light using one or more transmitters and receive reflected light pulses that are then detected by one or more receivers, so as to measure a distance to the target. Then, differences in laser return times and wavelengths can be used to make digital three dimensional (3D) representations of the target. In an example, determining the distance between the LiDAR device and the target involves measurement of time of flight (ToF) of laser light from the transmitter to the receiver.

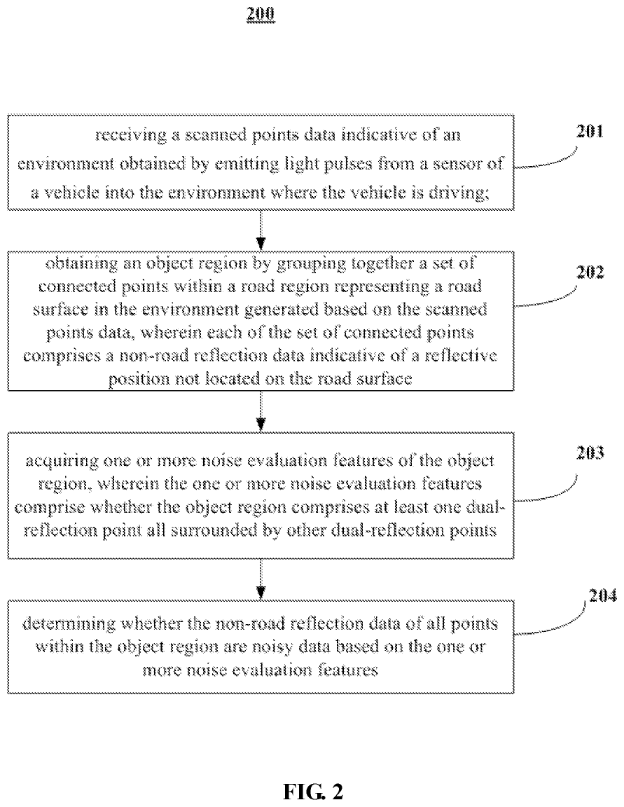

FIG. 2 depicts a flow chart of a process 200 of noise filtering for LiDAR devices according to an embodiment of the present disclosure. Referring to FIG. 2, in step 201, a scanned points data indicative of an environment is received, the scanned points data is obtained by emitting light pulses from a sensor of a vehicle into the environment where the vehicle is driving. In some examples, the scanned points data is a collection of scanned points indicating a digital 3D representation of the environment, each of which is corresponding to a light pulse emitted from the sensor of the vehicle into the environment and detected after it is reflected by the environment. As mentioned above, the scanned points data can be determined based on the ToF of each light pulse and its emitting direction.

It should be noted that the scanned points data may be provided in any form that can be used to determine a spatial position of each scanned points. In some examples, the scanned points data may include a set of spatial coordinates of each scanned points. In other examples, the scanned points data may include time delays between emitting the light pulses and receiving the corresponding returning light pulses, together with emitting directions of the light pulses. In some instances, the scanned points data may include additional attributes associated with the light pulses, such as light intensities or initial diameters of the light pulses.

The scanned points data may be used to generate a two dimensional (2D) or 3D environment image that includes pixels indicative of reflective positions of objects in the environment. As an example, the scanned points within the scanned points data may be projected onto a conceptual 2D cylindrical surface positioned around the vehicle or virtually positioned around the vehicle in a virtual rendering so as to obtain the pixels correspond to scanned points data. In step 202, an object region is obtained by grouping together a set of connected points within a road region representing a road surface, each of which includes a non-road reflection data indicative of a reflective position not located on the road surface. The road region may be detected based on the scanned points data using detection algorithms, such as region growing, segmentation and clustering, machine learning and multi-scale extraction and refinement, and active contour based segmentation. In some examples, the road surface can be a flat or slightly wavy surface without substantial potholes or bumps, which does not imply whether the vehicle can drive or not. The potholes or bumpers herein refer to a cluster of pixels that occupy at least a predetermined area and have a height substantially different from their surrounding pixels in the road surface. In some examples, all the objects on a road, such as other vehicles, vegetation, road curbs, or human beings, could be treated as bumps. In this situation, a border of the road surface can be determined by detecting potholes or bumps on a ground surface of the environment. Specifically, in some examples, once finding a pothole or a bump, it will be determined as a part of the border of the road surface.

In the step, the road region refers to a region within a 2D environment image representing a road surface (and potential object(s) on the road surface) in the environment, and the set of connected points is a set of points whose corresponding pixels are connected and within the road region. As mentioned above, in some examples, the 2D environment image is a planar graph formed by a plurality of pixels, and each pixel represents a projection of a point in the scanned points data on the planar graph. In this situation, “two pixels are connected” means they are adjacent to each other in the planner graph. Specifically, in some examples, the 2D environment image is a planar graph formed by an array of pixels with rows and columns. In this situation, each non-peripheral pixel in the array may have four connected pixels, which are its upper adjacent pixel and lower adjacent pixel in the column direction, and its right adjacent pixel and left adjacent pixel in the row direction. Accordingly, each point of the set of connected points has at least one other point in the set of connected points that is adjacent thereto.

In addition, each of the set of connected points should include a non-road reflection data indicative of a reflective position not located on the road surface. As mentioned before, the non-road reflection data may include any form of data that can be used to determine a spatial position of a reflective position not located on the road surface. In some examples, the non-road reflection data may include a spatial coordinate of a reflective position not located on the road surface. In other examples, the non-road reflection data may include time delay between emitting a light pulse and receiving a corresponding light pulse reflected from a position not located on the road surface, and an emitting direction of the light pulse.

In step 203, one or more noise evaluation features of the object region are acquired. The evaluation features can be used to determine in the subsequent step whether the object region indicates an object associated with noisy data which can be removed. In some embodiments, the one or more noise evaluation features include whether the object region includes at least one dual-reflection point all surrounded by other dual-reflection points. For example, if a dual-reflection point is all surrounded by other dual-reflection points, it may indicate that this dual-reflection point is at least not at an edge of an object, and thus should be a portion of a semi-transparent object. Furthermore, the one or more noise evaluation features may also include whether the object region is at a substantial height relative to the ground, and if yes, it may indicate that the object indicated by the object region is flying in the air and may be associated with noisy data that can be removed.

In step 204, whether the non-road reflection data of all points within the object region are noisy data is determined based on the one or more noise evaluation features. Reasons that the dual reflection points occur include dual reflections of the emitted pulse by semi-transparent objects such as exhaust gas, smog, smoke or vapor in the air, and dual reflections by small particles or edges of objects in the paths of the emitted pulses as well as the road surface behind such particles and edges of objects, for example. If a dual-reflection point is all surrounded by other dual-reflection points, it indicates that this dual-reflection point is at least not at an edge of an object, and thus should be a portion of a semi-transparent object as exhaust gas, smog and the like. Since these types of objects may not affect the driving of the vehicle and can be ignored, the non-road reflection data of all points within the object region having a dual-reflection point all surrounded by other dual-reflection points is considered as noisy data in some examples.

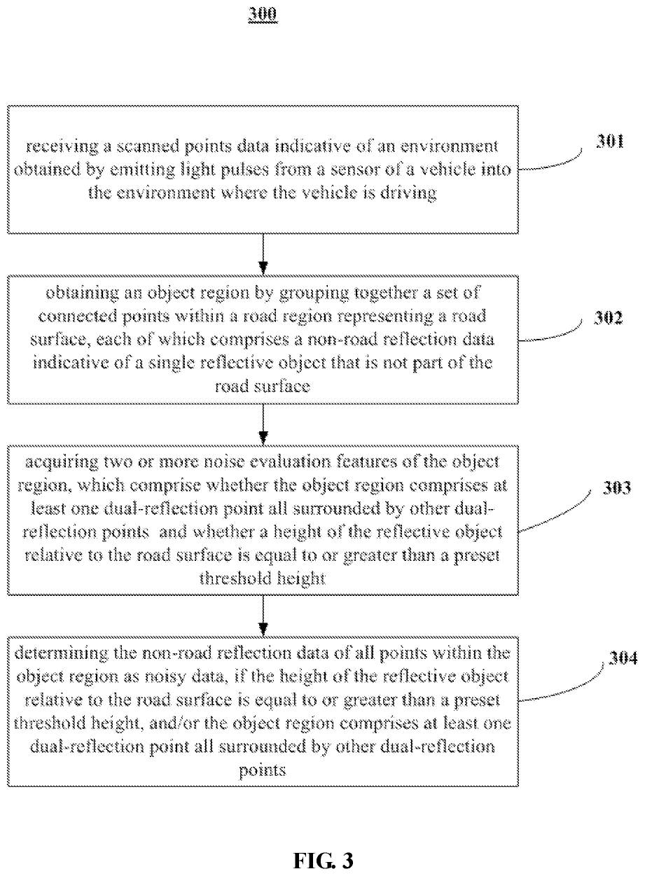

FIG. 3 depicts a flow chart of another process 300 of noise filtering for LiDAR devices according to an embodiment of the present disclosure. Referring to FIG. 3, in step 301, a scanned points data indicative of an environment is received, and the scanned points data is obtained by emitting light pulses from a sensor of a vehicle into the environment where the vehicle is driving. Step 301 is corresponding to step 201, and thus will not be detailed here.

In step 302, an object region is obtained by grouping together a set of connected points within a road region representing a road surface, each of which includes a non-road reflection data indicative of a single reflective object that is not part of the road surface. The difference between step 302 and step 202 is that every point within the object region obtained in step 302 includes non-road reflection data indicative of a single reflective object, and the reflective object is not part of the road surface. Any algorithms or methods that can be used to identify a reflective object in the environment based on the scanned points data can be used to determine the set of connected points in step 302.

There are many algorithms for point cloud segmentation. In some instances, an object region indicative of a segmented object can be obtained by implementing a region-based segmentation method. Specifically, in some examples, a point including a non-road reflection data in the scanned points data is selected as an initial point of the object region in a first sub-step of step 302. In some examples, the selected point may not be a point determined as belonging to another object in a previous segmentation. In a second sub-step of step 302 after the first sub-step, a spatial distance between the selected point and each of its connected points is respectively evaluated. In some examples, the connected points of the selected point are corresponding to pixels connected to the pixel of the selected point. If the spatial distance is less than a dynamic or static threshold and the connected point includes a non-road reflection data, the connected point should be added into the object region in a third sub-step of step 302 after the second sub-step.

After that, the second sub-step will be repeated for each newly added point in the object region. This process will be ended if no more connected point is added into the object region in the third sub-step. It should be noted that, the static threshold should be greater than a typical noise level, and the dynamic threshold should be calculated each time before performing the second sub-step. In some examples, both the static threshold and the dynamic threshold should be compared with the spatial distance, and a connected point should be added into the object region only if the spatial distance is less than the dynamic and static threshold.

In some instances, a minimum width and/or maximum width of objects on the road are preset, and a set of connected points will be classified into different sets if a width of the object region is greater than the maximum width.

In some instances, an object region may be firstly obtained by grouping together all connected points having a non-road reflection data indicative of a reflective position not located on the road surface, and then steps after step 302 can be performed to update a border of the object region. Specifically, the above mentioned algorithms or methods for identifying a reflective object based on the scanned points data may be implemented on all points within the object region to identify a set of points having non-road reflection data indicative of a single reflective object. Then, the border of the object region can be updated by deleting other non-identified or desired points within the object region.

In step 303, two or more noise evaluation features of the object region are acquired. In some embodiments, the two or more noise evaluation features include whether the object region includes at least one dual-reflection point all surrounded by other dual-reflection points and whether a height of the reflective object relative to the road surface is equal to or greater than a preset threshold height. The height of the reflective object relative to the road surface can be used to indicate whether the object is flying in the air or not.

In step 304, whether the non-road reflection data of all points within the object region are determined as noisy data or not based on the two or more noise evaluation features acquired in step 303. A height of a reflective object relative to the road surface that is equal to or greater than a preset threshold height indicates that the reflective object is in an off-ground state. Since off-ground state or flying objects above the road surface are generally flying insects, dust or exhaust gas, which usually have little influence on the driving of the vehicle, the non-road reflection points data indicative of an off-ground state object can be usually determined as noisy data. In some examples, the non-road reflection data of all the points within the object region is determined as noisy data in step 304, if the height of the reflective object relative to the road surface is equal to or greater than a preset threshold height. In other words, the reflective object indicated by the non-road reflection data of all points within the object region is determined as a noisy object, if the height of the reflective object relative to the road surface is equal to or greater than the preset threshold height. In some embodiments, the preset threshold height may be selected from a range from 0.5 m to 1.2 m, preferably 0.6 m.

As mentioned above, a dual-reflection point all surrounded by other dual-reflection points indicates that this dual reflection point is a portion of a semi-transparent object, which is generally determined as a noisy object that can be ignored. In some instances, the non-road reflection data of all points within the object region is determined as noisy data in step 304, if the object region includes at least one dual-reflection point all surrounded by other dual-reflection points.

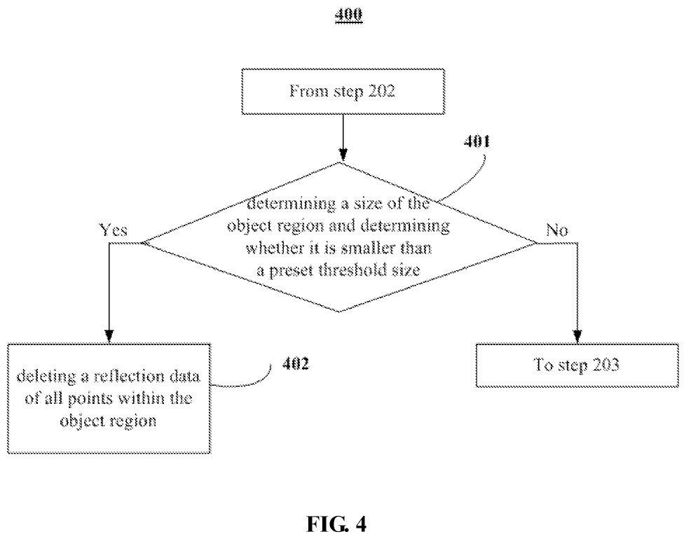

FIG. 4 depicts a flowchart of an example process 400 performed between step 202 and step 203 of the process 200 of FIG. 2. Referring to FIG. 4, in step 401, a size of the object region is determined, which is compared with a preset threshold size. Any parameter for identifying the dimension or size of the object region can be used, e.g., a perimeter, an area, a maximum distance between two edge points of the object region, or other suitable parameters. Taking the area of the object region as an example, the area of the object region can be determined by adding the areas of all the points within the object region together. An area of each point can be a preset value, or can be respectively calculated based on the reflection data associated therewith. The determined area of the object region is then compared with a preset threshold area, which is selected from a range from 0.02 m² to 0.12 m², preferably smaller than 0.09 m². It can be appreciated that the preset threshold area can vary depending on the distance from the object to the vehicle, because the light pulse for detection generally has a divergence such as 3 mrad, which may affect the resolution of the detection. Similarly, any other parameter indicating the size of the object region can be compared with the corresponding preset threshold size.

An object region having a size smaller than the preset threshold size usually indicates that it is a small reflective object, such as a rain drop, a snowflake or a small insect, which may not affect the driving of the vehicle and thus can be ignored. Therefore, if the size of the object region is smaller than the preset threshold size, then step 402 is performed, reflection data of all points within the object region is deleted from the scanned points data. If the size of the object region is equal to or greater than the preset threshold size, then step 203 and its following steps of process 200 are performed.

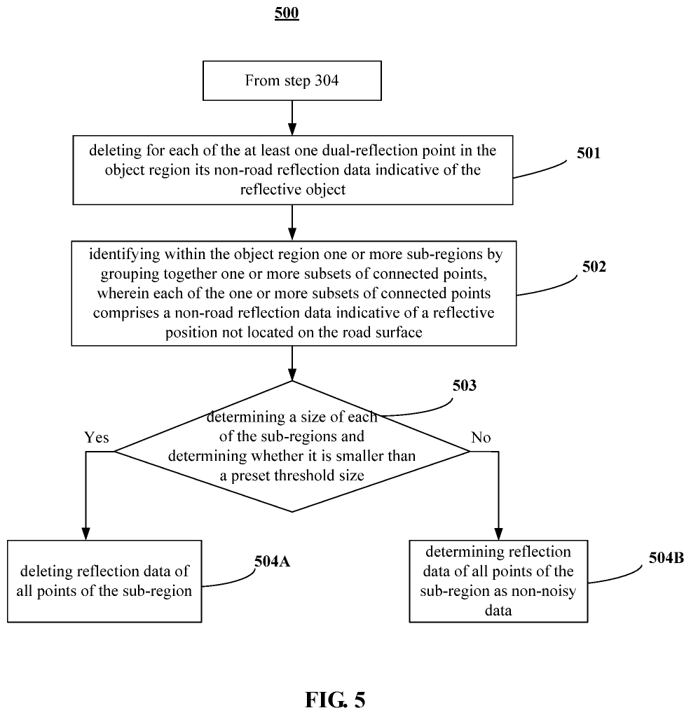

FIG. 5 depicts a flow chart of a process 500 performed after step 304 of process 300. Referring to FIG. 5, if the non-road reflection data of all points within the object region is determined as noisy data in step 304, the non-road reflection data indicative of the reflective object of each of the at least one dual-reflection point within the object region is deleted in step 501. For example, for a dual-reflection point including reflection data indicative of a reflective position on the reflective object and a reflective position on the road surface, only the reflection data indicative of the reflective position on the reflective object is deleted. It should be noted that the term “dual-reflection point” in the present disclosure is not limited to a point having reflection data indicative of only two reflection positions. Actually, it refers to a point having reflection data indicative of two or more reflection positions. For a point including reflection data indicative of three reflection positions, if the non-road reflection data of all points within the object region is determined as noisy data, all reflection data indicative of reflective positions not located on the road surface will be deleted. Since the reflection data indicative of a reflective position on the road surface usually is the farthest reflective position, in some instances, all reflection data except for the one indicative of the farthest reflective position of each dual-reflection point is deleted in step 501.

After step 501 is performed, the reflection data indicative of a semi-transparent portion is deleted, and the dual-reflection points in the object region only include reflection data indicative of the road surface. Then, the remaining points including the non-road reflection data within the object region still need to be evaluated. Since these points may not be connected due to the deletion of non-road reflection data in step 501, the object region need to be updated to further evaluated the remaining points. Therefore, in step 502, one or more sub-regions indicative of one or more sub-objects within the object region is identified. Specifically, one or more sub-regions are identified by grouping together one or more subsets of points within the object region, and each of the one or more subsets of points includes a reflection data indicative of a reflective position of the first reflective object. Step 502 is corresponding to step 202 or 302, and thus will not be detailed here.

In step 503, a size of each of the sub-regions is determined and respectively compared with a preset threshold size. Step 503 is corresponding to step 401, and as mentioned above, a sub-regions having a size smaller than the preset threshold value, usually indicates a small sub-objects object that can be ignored. Therefore, if the size of one of the sub-regions is smaller than the preset threshold value selected from a range from 0.02 m² to 0.12 m², then step 504A is performed, and specifically reflection data of all points of the sub-region can be deleted. In other words, if the size of one of the sub-regions is equal to or greater than the preset threshold value, then step 504B is performed, and thus reflection data of all points of the sub-region are determined as non-noisy data which will be considered during subsequent vehicle navigation based on the Lidar data.

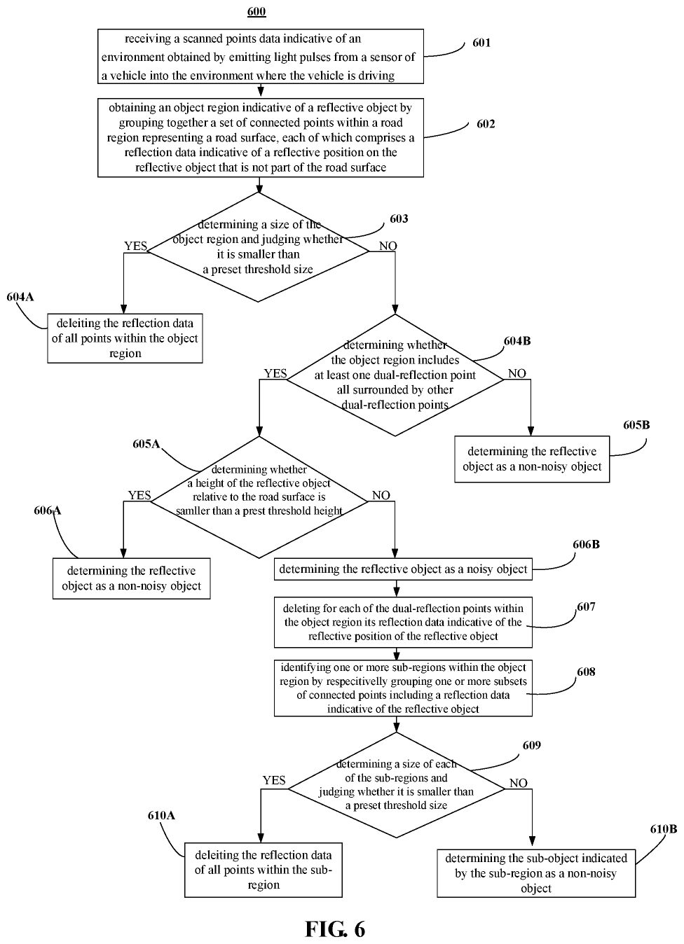

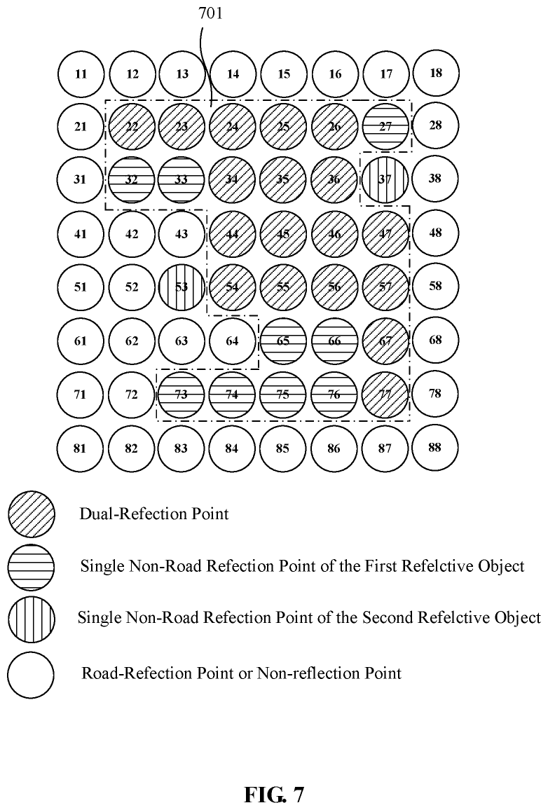

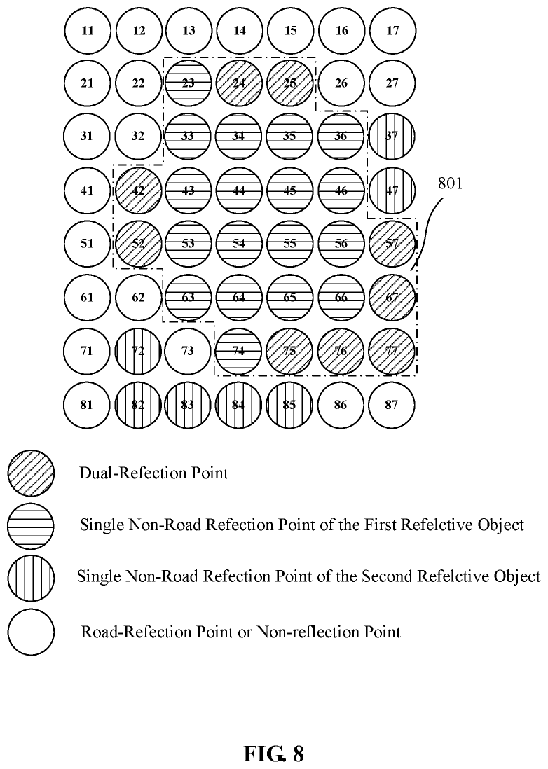

FIG. 6 depicts a flow chart of another process 600 of noise filtering for LiDAR devices according to an embodiment of the present disclosure. FIG. 7 depicts an environment image of a plurality of scanned points within a road region according to an embodiment of the present disclosure. FIG. 8 depicts an environment image of a plurality of scanned points within a road region according to another embodiment of the present disclosure. The process 600 will be specifically depicted according to the embodiments as shown in FIGS. 7 and 8.

FIG. 7 depicts an environment image of a plurality of scanned points within a road region according to an embodiment of the present disclosure. Each of the scanned points in the two-dimensional image of FIG. 7 is corresponding to a light pulse emitted from a sensor of a vehicle into the environment and detected after it is reflected by the environment. As shown in FIG. 7, blank points like 11, 12 and 13 are road reflection points or non-reflection points, each of which includes either only a reflection data indicative of a reflective position on a road surface in the environment or no reflection data. Points like 22, 23 and 24 are dual-reflection points, each of which includes two or more reflection data indicative of two or more reflective positions in response to a single emitted pulse, and at least one of the reflective positions is on a first reflective object that is not part of the road surface. Reasons that the dual reflection points occur include dual reflections of the emitted pulse by semi-transparent objects such as exhaust gas, smog, smoke or vapor in the air, and dual reflections by small particles or edges of objects in the paths of the emitted pulses as well as the road surface behind such particles and edges of objects, for example. Points like 27, 32 and 33 are single non-road refection points of the first reflective object, each of which only includes a reflection data indicative of a reflective position on the first reflective object in response to a single emitted pulse. Points like 53 and 37 are non-road refection points of a second reflective object, each of which only includes a reflection data indicative of a reflective position on the second reflective object in response to a single emitted pulse, and the second reflective object is also not part of the road surface.

Some steps as depicted in FIG. 6 are now specifically described with reference to the example shown in FIG. 7.

Firstly, in step 602, an object region 701 indicative of a reflective object is obtained by grouping together a set of connected points within the road region as shown in FIG. 7, each of the set of connected points includes a reflection data indicative of a reflective position on a reflective object that is not part of the road surface. As shown in FIG. 7, the object region 701 is indicative of a first reflective object, and the set of connected points are points including at least one reflection data indicative of a reflective position on the first reflective object. The points 37 and 53 do not belong to the set of connected points, since these points include only a reflection data indicative of a reflective position on a second reflective object. The first reflective object and the second reflective object may be at different distances away from the vehicle. The specific methods and rules for identifying the set of connected points and obtaining the object region 701 have been described above in detail and will not be detailed again here.

After that, in step 603, a size of the object region 701 is determined, and the determined size of the region 701 is compared with a preset threshold value. Taking the area of the region 701 as an example of the size of the object region 701, the area can be determined by adding the areas of all the points within the object region 701 together. As mentioned above, the area of each point can be a preset value. In other examples, the area of each point can be respectively calculated or measured based on the reflection data associated therewith. The determined area of the object region 701 is then compared with a preset threshold area, which is selected from a range from 0.02 m² to 0.12 m², preferably smaller than 0.09 m².

In step 604A, if the size of the object region 701 is smaller than the preset threshold value, the reflection data of all points within the object region 701 are deleted. For example, the object region 701 having an area smaller than 0.09 m² usually indicates that the first reflective object is small, such as a rain drop, a snowflake, etc., which may not affect the driving of the vehicle and thus can be ignored.

In step 604B, if the object region 701 is equal to or greater than the preset threshold value, it is to be determined further whether the object region 701 includes at least one dual-reflection point all surrounded by other dual-reflection points. As shown in FIG. 7, points like 35 and 45 are dual-reflection points all surrounded by other dual-reflection points. If a dual-reflection point is all surrounded by other dual-reflection points, indicating that this dual reflection point is at least not at an edge of an object, and thus should be a portion of a semi-transparent object.

Since point 35 or 45 is identified in the object region 701, step 605A is further preformed. Specifically, a height of the first reflective object relative to the road surface is determined and compared with a preset threshold height.

If the height of the first reflective object is smaller than the preset threshold height, step 606A is further performed. Specifically, the first reflective object is determined as a non-noisy object and the reflection data of the all points within the object region 701 will not be deleted or ignored.

If the height of the first reflective object is equal to or greater than the preset threshold height, step 606B is further performed. Specifically, the first reflective object is determined as a noisy object, such as a semi-transparent smoke which reflects a light pulse twice due to the semi-transparency. Such noisy object will be not considered during subsequent road navigation. Afterwards, in step 607, for each of the dual-reflection points within the object region 701, its reflection data indicative of the reflective position of the first reflective object is deleted, because such reflection data is noisy data and will adversely affect object recognition. Then, step 608 is performed to identify one or more sub-regions indicative of one or more sub-objects within the object region. Specifically, one or more sub-regions are identified by grouping together one or more subsets of points within the object region 701, and each of the one or more subsets of points includes a reflection data indicative of a reflective position of the first reflective object. Step 608 is corresponding to step 602, which will not be detailed here. As shown in FIG. 7, two sub-regions are identified, which are a first sub-region obtained by grouping points 32, 33 together and a second sub-region obtained by grouping points 65, 66, 73, 74, 75 and 76 together. It should be noted that, as mentioned above, the isolated point 27, which is not connected to any other points including a reflection data indicative of a reflective position of the first reflective object, will be directly treated as a noisy point and the reflection data of the point 27 will be ignored or deleted.

As shown in FIG. 6, step 609 is further performed, a size of the first sub-region and the second sub-region are determined, and the determined sizes of the first sub-regions and the second sub-regions are respectively compared with a preset threshold value. As shown in FIG. 7, it is assumed that the size of the first sub-region is smaller than the preset threshold value and the size of the second sub-regions is greater than the preset threshold value. Under such circumstances, step 610A is performed for the first sub-region, and thus the reflection data of point 32 and 33 within the sub-region will be deleted or ignored. For the second sub-region, step 610B is performed, the sub-object indicated by the second sub-region is determined as a non-noisy object and the reflection data of points 65, 66, 73, 74, 75 and 76 will not be deleted.

FIG. 8 depicts another environmental image of a plurality of scanned points within a road region according to another embodiment of the present disclosure. Each of the scanned points in the two-dimensional image of FIG. 8 is corresponding to a light pulse emitted from a sensor of a vehicle into the environment and detected after it is reflected by the environment. As shown in FIG. 8, blank points like 11, 12 and 13 are road reflection points or non-reflection points, each of which includes either a reflection data indicative of a reflective position on the road surface or no reflection data. Points like 24 and 25 (marked by inclined lines) are dual-reflection points, each of which includes two or more reflection data indicative of two or more reflective positions in response to a single emitted pulse, the reflective positions include a reflective position on a first reflective object that is not part of the road surface. Points like 23 and 33 (marked by horizontal lines) are single non-road refection points of the first reflective object. Points like 72 and 82 (marked by vertical lines) are non-road refection points of a second reflective object not part of the road surface.

Some steps as depicted in FIG. 6 are now specifically described with reference to the example shown in FIG. 8.

Firstly, in step 602, an object region 801 indicative of a reflective object is obtained by grouping together a set of connected points within the road region as shown in FIG. 8. As shown in FIG. 8, the object region 801 is indicative of the first reflective object, and the set of connected points are points including at least one reflection data indicative of a reflective position on the first reflective object. The points 72, 82, 83, 84, 85, 37 and 47 do not belong to the set of connected points, since these points do not include the reflection data indicative of the first reflective object.

After that, in step 603, a size of the object region 801 is determined, and the determined size of the region 801 is compared with a preset threshold value. The process proceeds with step 604B since it is determined that the object region 801 is greater than the preset threshold value, i.e., it is to be determined further whether the object region 801 includes at least one dual-reflection point all surrounded by other dual-reflection points. As shown in FIG. 8, there is no dual-reflection points all surrounded by other dual-reflection points, and thus step 605B is further performed. The first reflective object is determined as a non-noisy object and the reflection data of all points within the object region 801 will not be deleted or ignored.

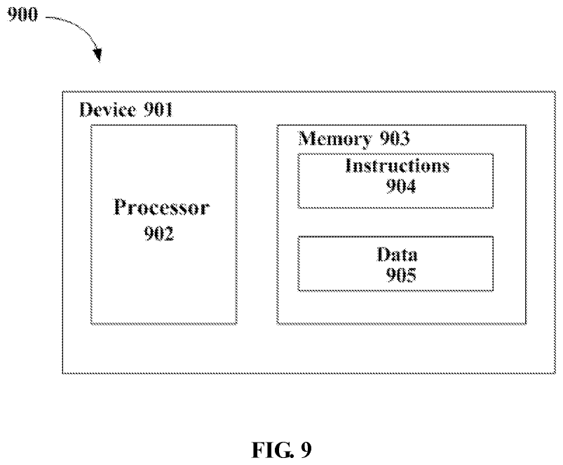

FIG. 9 depicts a schematic diagram of a device 901 for filtering noise for LiDAR devices according to an embodiment of the present disclosure. As shown in FIG. 9, the device 901 may include a processor 902 and a memory 903. The memory 903 of device 901 stores information accessible by the processor 902, including instructions 904 that may be executed by the processor 902. The memory 903 also includes data 905 that may be retrieved, processed or stored by the processor 902. The memory 903 may be of any type of tangible media capable of storing information accessible by the processor, such as a hard-drive, memory card, ROM, RAM, DVD, CD-ROM, write-capable, and read-only memories. The processor 902 may be any well-known processor, such as commercially available processors. Alternatively, the processor may be a dedicated controller such as an ASIC.

The instructions 904 may be any set of instructions to be executed directly (such as machine code) or indirectly (such as scripts) by the processor. In that regard, the terms “instructions,” “steps” and “programs” may be used interchangeably herein. The instructions may be stored in object code format for direct processing by the processor, or in any other computer language including scripts or collections of independent source code modules that are interpreted on demand or compiled in advance. Data 905 may be retrieved, stored or modified by processor 902 according to the instructions 904. For example, although the system and method are not limited by any particular data structure, the data may be stored in computer registers, in a relational database as a table having a plurality of different fields and records, or XML documents. The data may also be formatted in any computer-readable format such as, but not limited to, binary values, ASCII or Unicode. Moreover, the data may comprise any information sufficient to identify the relevant information, such as numbers, descriptive text, proprietary codes, pointers, references to data stored in other memories (including other network locations) or information that is used by a function to calculate the relevant data. In an example, the instructions 904 may be any set of instructions related to the processes as described before.

Although FIG. 9 functionally illustrates the processor and memory as being within the same block, the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

Various embodiments have been described herein with reference to the accompanying drawings. It will, however, be evident that various modifications and changes may be made thereto, and additional embodiments may be implemented, without departing from the broader scope of the invention as set forth in the claims that follow.

Further, other embodiments will be apparent to those skilled in the art from consideration of the specification and practice of one or more embodiments of the invention disclosed herein. It is intended, therefore, that this disclosure and the examples herein be considered as exemplary only, with a true scope and spirit of the invention being indicated by the following listing of exemplary claims.

What is claimed is:

1. A method for noise filtering for LiDAR, comprising:
receiving a scanned points data indicative of an environment obtained by emitting light pulses from a sensor of a vehicle into the environment where the vehicle is driving;
obtaining an object region by grouping together a set of connected points within a road region representing a road surface in the environment generated based on the scanned points data, wherein each of the set of connected points comprises a non-road reflection data indicative of a reflective position not located on the road surface;
acquiring one or more noise evaluation features of the object region, wherein the one or more noise evaluation features comprise whether the object region comprises at least one dual-reflection point all surrounded by other dual-reflection points;
determining whether the non-road reflection data of all points within the object region are noisy data based on the one or more noise evaluation features.

2. The method of claim 1, wherein the non-road reflection data of the set of connected points are indicative of a single reflective object.

3. The method of claim 1, wherein after obtaining the object region, the method further comprises:
identifying within the object region all points each comprising a non-road reflection data indicative of a reflective position on a single reflective object;
updating a border of the object region by deleting unidentified points within the object region.

4. The method of claim 1, wherein determining whether the non-road reflection data of all points within the object region are noisy data comprises:
determining the non-road reflection data of all points within the object region as noisy data if the object region comprises at least one dual-reflection point all surrounded by other dual-reflection points.

5. The method of claim 2, wherein two or more noise evaluation features associated with the object region are acquired, and the two or more noise evaluation features comprise further whether a height of the reflective object relative to the road surface is equal to or greater than a preset threshold height.

6. The method of claim 5, wherein determining whether the non-road reflection data of all points within the object region are noisy data comprises:
determining the non-road reflection data of all points within the object region as noisy data, if the height of the reflective object relative to the road surface is equal to or greater than a preset threshold height, and/or the object region comprises at least one dual-reflection point all surrounded by other dual-reflection points.

7. The method of claim 1, wherein before acquiring one or more noise evaluation features of the object region, the method further comprises:
determining a size of the object region;
deleting reflection data of all points within the object region if the size of the object region is equal to greater than a preset threshold size.

8. The method of claim 6, wherein after determining the non-road reflection data of all points within the object region as noisy data, the method further comprises:
deleting the non-road reflection data of each of the at least one dual-reflection point in the object region.

9. The method of claim 8, wherein after deleting the non-road reflection data of each of the at least one dual-reflection point in the object region, the method further comprises:
identifying within the object region one or more sub-regions by grouping together one or more subsets of connected points, wherein each of the one or more subsets of connected points comprises a non-road reflection data indicative of a reflective position not located on the road surface;
determining a size of each of the one or more sub-regions; and
deleting reflection data of all points of the sub-regions having a size smaller than the preset threshold size.

10. A device for noise filtering for LiDAR, comprising:
a processor; and
a memory configured to store an instruction executable by the processor;
wherein the processor is configured to:
receive a scanned points data indicative of an environment obtained by emitting light pulses from a sensor of a vehicle into the environment where the vehicle is driving;
obtain an object region by grouping together a set of connected points within a road region representing a road surface in the environment generated based on the scanned points data, wherein each of the set of connected points comprises a non-road reflection data indicative of a reflective position not located on the road surface;
acquire one or more noise evaluation features of the object region, wherein the one or more noise evaluation features comprise whether the object region comprises at least one dual-reflection point all surrounded by other dual-reflection points;
determine whether the non-road reflection data of all points within the object region are noisy data based on the one or more noise evaluation features.

11. The device of claim 10, wherein the non-road reflection data of the set of connected points are indicative of a single reflective object.

12. The device of claim 10, wherein after obtaining the object region, the processor is further configured to:
identify within the object region all points comprising a non-road reflection data indicative of a reflective position on a single reflective object;
update a border of the object region by deleting all points that do not comprise a non-road reflection data indicative of a reflective position on the reflective object.

13. The device of claim 10, wherein determining whether the non-road reflection data of all points within the object region are noisy data comprises:
determining the non-road reflection data of all points within the object region as noisy data if the object region comprises at least one dual-reflection point all surrounded by other dual-reflection points.

14. The device of claim 11, wherein two or more noise evaluation features associated with the object region are acquired, and the two or more noise evaluation features comprise whether a height of the reflective object relative to the road surface is equal to or greater than a preset threshold height.

15. The device of claim 14, wherein determining whether the non-road reflection data of all points within the object region are noisy data comprises:
determining the non-road reflection data of all points within the object region as noisy data, if the height of the reflective object relative to the road surface is equal to or greater than a preset threshold height, and/or the object region comprises at least one dual-reflection point all surrounded by other dual-reflection points.

16. The device of claim 10, wherein before acquiring one or more noise evaluation features of the object region, the processor is further configured to:
determine a size of the object region;
delete reflection data of all points within the object region if the size of the object region is equal to greater than a preset threshold size.

17. The device of claim 15, wherein after determining the non-road reflection data of all points within the object region as noisy data, the processor is further configured to:
delete the non-road reflection data of each of the at least one dual-reflection point in the object region.

18. The device of claim 17, wherein after deleting the non-road reflection data of each of the at least one dual-reflection point in the object region, the processor is further configured to:
identify within the object region one or more sub-regions by grouping together one or more subsets of connected points, wherein each of the one or more subsets of connected points comprises a non-road reflection data indicative of a reflective position not located on the road surface;
determine a size of each of the one or more sub-regions; and
delete a reflection data of all points of the sub-regions having a size smaller than the preset threshold size.
